(19) United States
(12) Patent Application Publication
(10) Pub. No.: US 2025/0335222 A1
(43) Pub. Date: Oct. 30, 2025

(54) DIGITAL ASSISTANT CREATION

(71) Applicant: Beijing Zitiao Network Technology Co., Ltd., Beijing (CN)

(72) Inventor: Yunpeng Chen, Beijing (CN)

(21) Appl. No.: 18/826,735

(22) Filed: Sep. 6, 2024

(30) Foreign Application Priority Data
Apr. 30, 2024 (CN) 202410544496.2

(51) Int. Cl. G06F 9/451

(52) U.S. Cl. CPC G06F 9/453

(57) ABSTRACT

Embodiments of this specification provides a method, apparatus, device, medium and product for digital assistant creation. The method includes: obtaining registration information of a first assistant application platform, the registration information comprising at least a first interface definition for releasing a digital assistant on the first assistant application platform; receiving release confirmation information for a target digital assistant, the release confirmation information indicating release of the target digital assistant to the first assistant application platform; and in response to the release confirmation information, releasing the target digital assistant to the first assistant application platform based on at least the first interface definition. Therefore, the assistant creation platform is able to have the ability to customize the assistant application platform, thus enabling the assistant application platform to access the assistant creation platform independently.

### CROSS-REFERENCE TO RELATED APPLICATIONS

This application claims priority to Chinese Patent Application No. 202410544496.2, filed on Apr. 30, 2024, and entitled “METHOD, APPARATUS, ELECTRONIC DEVICE, MEDIUM AND PRODUCT FOR DIGITAL ASSISTANT CREATION”, the entirety of which is incorporated here by reference.

### FIELD

Example embodiments of the present specification relate generally to the field of computer and, more particularly, to digital assistant creation.

### BACKGROUND

Digital assistants are provided to assist users in various task processing needs in different applications and scenarios. Digital assistants usually have intelligent dialogue and task processing capabilities. In the interaction process with a digital assistant, users input interaction messages, and the digital assistant responds to the user input with response messages. Typically, digital assistants can support user inputs providing questions in a natural language and then the digital assistants perform tasks and provide responses based on the understanding of the natural language input and logical inference capability of the digital assistant. Such digital assistant interaction has become popular and people are relying on it for interaction due to its flexible and convenient characteristics.

### SUMMARY

In a first aspect of the present disclosure, a method of digital assistant creation is provided. The method comprises: obtaining registration information of a first assistant application platform, the registration information comprising at least a first interface definition for releasing a digital assistant on the first assistant application platform; receiving release confirmation information for a target digital assistant, the release confirmation information indicating release of the target digital assistant to the first assistant application platform; and in response to the release confirmation information, releasing the target digital assistant to the first assistant application platform based on at least the first interface definition.

In a second aspect of the present disclosure, an apparatus for digital assistant creation is provided. The apparatus comprises: an information obtaining module configured to obtain registration information of a first assistant application platform, the registration information comprising at least a first interface definition for releasing a digital assistant on the first assistant application platform; an information receiving module configured to receive release confirmation information for a target digital assistant, the release confirmation information indicating release of the target digital assistant to the first assistant application platform; and a releasing module configured to release, in response to the release confirmation information, the target digital assistant to the first assistant application platform based on at least the first interface definition.

In a third aspect of the present disclosure, an electronic device is provided. The device comprises at least one processing unit; and at least one memory coupled to the at least one processing unit and storing instructions for execution by the at least one processing unit, the instructions, when executed by the at least one processing unit, causing the electronic device to perform operations that implement the method of the first aspect.

In a fourth aspect of the present disclosure, a computer-readable storage medium having a computer program stored thereon is provided. The computer program is executable by a processor to implement the method of the first aspect.

In a fifth aspect of the present disclosure, a computer program product is provided. The computer program product is tangibly stored in a computer storage medium and comprises computer-executable instructions that, when executed by a device, cause the device to perform operations that implement the method of the first aspect.

According to embodiments of the present disclosure, the assistant creation platform can have the ability to customize the assistant application platform, thereby enabling the assistant application platform to autonomously access the assistant creation platform. Further, based on the assistant creation platform, the creator can release the digital assistant created by the creator to the assistant application platform.

It would be appreciated that the content described in the section is neither intended to identify the key features or essential features of the present disclosure, nor is it intended to limit the scope of the present disclosure. Other features of the present disclosure will be readily understood through the following description.

### BRIEF DESCRIPTION OF DRAWINGS

The above and other features, advantages and aspects of the various embodiments of the present disclosure will become more apparent in combination with the accompanying drawings and with reference to the following detailed description. In the drawings, the same or similar reference symbols refer to the same or similar elements, wherein:

FIG. 1 illustrates a schematic diagram of an example environment.

FIG. 2 illustrates a schematic diagram of an example process for registering an assistant application platform.

FIG. 3A illustrates a schematic diagram of an example architecture for releasing a digital assistant to an assistant application platform.

FIG. 3B illustrates a schematic diagram of an example interface of a candidate platform list.

FIG. 4 illustrates a schematic diagram of an example architecture for a user to interact with a digital assistant.

FIG. 5 illustrates a flowchart of an example process for digital assistant creation.

FIG. 6 illustrates a schematic structural block diagram of an example apparatus for digital assistant creation.

FIG. 7 illustrates a block diagram of an example electronic device.

### DETAILED DESCRIPTION

The embodiments of the present disclosure will be described in more detail below with reference to the accompanying drawings. Although certain embodiments of the present disclosure are shown in the drawings, it would be appreciated that the present disclosure can be implemented in various forms and should not be interpreted as limited to the embodiments described in this specification. On the contrary, these embodiments are provided for a more thorough and complete understanding of the present disclosure. It would be appreciated that the accompanying drawings and embodiments of the present disclosure are only for the purpose of illustration and are not intended to limit the scope of protection of the present disclosure.

In the description of the embodiments of the present disclosure, the term “including”, and similar terms would be appreciated as open inclusion, that is, “including but not limited to”. The term “based on” would be appreciated as “at least partially based on”. The term “one embodiment” or “the embodiment” would be appreciated as “at least one embodiment”. The term “some embodiments” would be appreciated as “at least some embodiments”. Other explicit and implicit definitions may also be included below.

Unless expressly stated in this specification, performing a step “in response to A” does not mean that the step is performed immediately after “A”, but may include one or more intermediate steps.

It will be appreciated that the data involved in this technical solution (including but not limited to the data itself, data acquisition or use) shall comply with the requirements of corresponding laws, regulations and relevant provisions.

It will be appreciated that before using the technical solution disclosed in each embodiment of the present disclosure, users should be informed of the type, the scope of use, the use scenario, etc. of the personal information involved in the present disclosure in an appropriate manner in accordance with relevant laws and regulations, wherein the relevant user may include any type of rights subject, such as individuals, enterprises, groups.

For example, in response to receiving an active request from a user, a prompt message is sent to the user to explicitly prompt the user that the operation requested operation by the user will need to obtain and use personal information of the user, so that users may select whether to provide personal information to the software or the hardware such as an electronic device, an application, a server or a storage medium that perform the operation of the technical solution of the present disclosure according to the prompt information.

As an optional but non-restrictive implementation, in response to receiving an active request of the user, the method of sending prompt information to the user may be, for example, a pop-up window in which prompt information may be presented in text. In addition, pop-up windows may also contain selection controls for users to choose “agree” or “disagree” to provide personal information to electronic devices.

It will be appreciated that the above notification and acquisition of user authorization processes are only schematic and do not limit the implementations of the present disclosure. Other methods that meet relevant laws and regulations may also be applied to the implementation of the present disclosure.

As used in this specification, the term “model” can learn a correlation between respective inputs and outputs from training data, so that a corresponding output can be generated for a given input after training is completed. The generation of the model can be based on machine learning techniques. Deep learning is a machine learning algorithm that processes inputs and provides corresponding outputs by using multiple layers of processing units. A neural networks model is an example of a deep learning-based model. As used in this specification, “model” may also be referred to as “machine learning model”, “learning model”, “machine learning network”, or “learning network”, and these terms are used interchangeably.

With the rapid development of computer technology, modeling applications are becoming more and more embedded in society and production life. Currently, model-based applications can be categorized into three layers, which are model base layer, model development layer, and model application layer. Based on the model development platform, the user (sometimes called the creator of the assistant) can build different assistants (Bot). The creator of an assistant can organize invocation of the assistant of the model based on prompt messages, interfaces, and code. Creators can then release their created assistants to different assistant creation platforms.

However, the current assistant creation platforms require the assistant creation platform to actively interface with different assistant application platforms. In this way, a high development cost is caused by the need for the research and development within the assistant creation platform to carry out the development docking. Further, the differences between the various assistant application platforms cause a problem of high cost of adaptation. Accordingly, there is no way to access an unlimited number of assistant application platforms due to limited resources, e.g., certain assistant application platforms are not supported.

According to some embodiments of the present disclosure, an improved solution for digital assistant creation is provided. According to the solution, registration information of a first assistant application platform is obtained, the registration information comprising at least a first interface definition for releasing a digital assistant on the first assistant application platform. Then, release confirmation information is received for a target digital assistant, the release confirmation information indicating release of the target digital assistant to the first assistant application platform. Then, in response to the release confirmation information, the target digital assistant is released to the first assistant application platform based on at least the first interface definition.

Accordingly, this solution enables the assistant application platform to autonomously access the assistant creation platform. Further, with the assistant creation platform, the creator can release the created digital assistant to the assistant application platform.

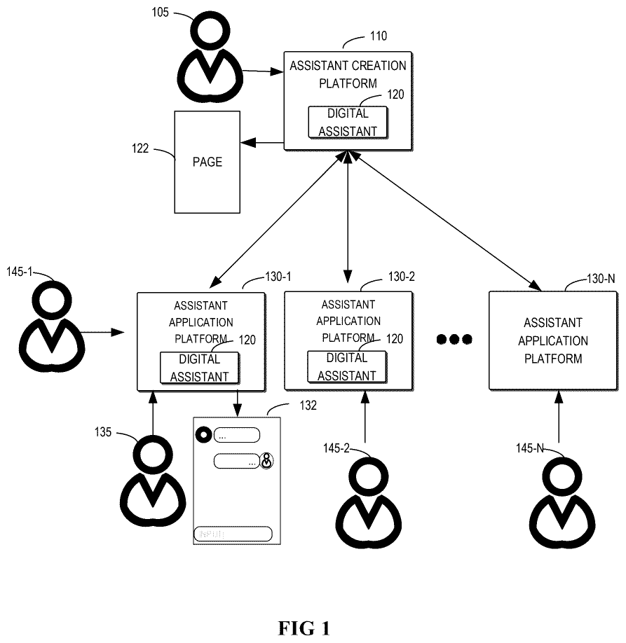

FIG. 1 illustrates a schematic diagram of an example environment 100 in which embodiments of the present disclosure can be implemented. The environment 100 involves an assistant creation platform 110 and N assistant application platforms 130-1, 130-2, . . . , 130-N, where N is an integer greater than or equal to one. For ease of discussion, the assistant application platforms 130-1, 130-2, . . . , 130-N may be collectively or individually referred to as assistant application platforms 130.

In some embodiments, the assistant application platforms 130-1, 130-2, . . . , 130-N may be deployed locally on the terminal devices of users 145-1, 145-2, . . . , 145-N, respectively, and/or may be supported by a remote server. For ease of discussion, users 145-1, 145-2, 145-N may be collectively or individually referred to as users 145. The assistant creation platform 110 may present corresponding pages to a user 145 based on an action of the user 145 to output to and/or receive information from the user 145. For example, the assistant creation platform 110 may receive registration information provided to the assistant creation platform 110 by the user 145 to enable the release of a digital assistant created based on the creation platform 110. The user 145 may be a provider or administrator of the corresponding assistant application platform 130.

As shown in FIG. 1, the assistant creation platform 110 can provide a creation and publication environment of a digital assistant for a user 105. In some embodiments, the assistant creation platform 110 can be a low-code platform that provides a collection of tools for digital assistant creation. The assistant creation platform 110 can support visual development for digital assistants, thereby allowing developers to skip the manual coding process and accelerate the development cycle and cost of applications. The assistant creation platform 110 can support any suitable platform for users to develop digital assistants and other types of applications, for example, it can include platforms based on application platform as a service (aPaaS). Such a platform can support users to efficiently develop applications, achieve application creation, application function adjustment, and other operations.

The assistant creation platform 110 can be deployed locally on a terminal device of the user 105 and/or can be supported by a remote server. For example, a client with the assistant creation platform 110 may be run on the terminal device of the user 105, which can support the interaction of the user with the assistant creation platform 110. In the case where the assistant creation platform 110 is run locally on the terminal device of the user, the user 105 can directly use the client to interact with the local assistant creation platform 110. In the case where the assistant creation platform 110 is run on a server level device, the server-side device can implement the provision of services to the client running on the terminal device based on the communication connection between the terminal device. The assistant creation platform 110 can present a corresponding page 122 to the user 105 based on the operation of the user 105 to output and/or receive information from the user 105.

In some embodiments, the assistant creation platform 110 may be associated with a corresponding database, which stores data or information required for the digital assistant creation process supported by the assistant creation platform 110. For example, the database may store code and description information corresponding to various functional modules that make up the digital assistant. The assistant creation platform 110 may also perform operations such as calling, adding, deleting, updating, etc. on the functional modules in the database. The database may also store operations that can be performed on different functional blocks. For example, in a scenario where a digital assistant is to be created, the assistant creation platform 110 may call corresponding functional blocks from the database to build the digital assistant.

In some embodiments of the present disclosure, the user 105 may create a digital assistant 120 on the assistant creation platform 110 as needed and release the digital assistant 120. The digital assistant 120 may be released to one or more assistant application platforms 130 (sometimes referred to as “release channelers” or simply “channelers” for digital assistants). After release, the digital assistant 120 running on the assistant application platform 130 may be provided for dialog interaction with the user 135. The user 135 may be a user interacting with the digital assistant 120 or other functions provided on the corresponding assistant application platform 130. A client of the assistant application platform 130 may present an interaction window 132 of the digital assistant 120, such as a session window, in a client interface. Only the interaction between the digital assistant 120 and the user 135 on the assistant application platform 130-1 is illustrated, and other assistant application platforms 130 may provide similar interactions between the digital assistant and the user.

The digital assistant 120 serves as an intelligent assistant with intelligent dialog and information processing abilities. The user 135 may enter a session message in the session window, and the digital assistant 120 may determine a response message and present it to the user in the interaction window 132 based on the configuration information created. In some embodiments, depending on the configuration of the digital assistant 120, the interaction message with the digital assistant 120 may include a multimodal form of message, such as a text message (e.g., natural language text), a speech message, an image message, a video message, and the like.

The assistant creation platform 110 and/or the assistant application platform 130 may run on an appropriate electronic device. The electronic device in this specification may be any type of computing-capable device, including a terminal device or a server-side device. The terminal device may be any suitable type of mobile terminal device, fixed terminal device, or portable terminal device, including mobile phones, desktop computers, laptop computers, notebook computers, netbook computers, tablet computers, media computers, multimedia tablets, personal communication system (PCS) devices, personal navigation devices, personal digital assistants (PDAs), audio/mobile player, digital cameras/video cameras, positioning devices, television receivers, radio broadcast receivers, e-book devices, gaming devices, or any combination thereof, including accessories and peripherals of these devices, or any combination thereof. Server-side devices may include, for example, computing systems/servers, such as mainframes, edge computing nodes, computing devices in cloud environments, and so on. In some embodiments, the assistant creation platform 110 and/or the assistant application platform 130 may be implemented based on cloud service.

It will be appreciated that the structure and function of the environment 100 is described for the purposes of illustration only, without implying any limitation on the scope of the present disclosure. For example, although FIG. 1 shows a single user interacting with the assistant creation platform 110 and a single user interacting with the assistant application platform 130, multiple users can actually access the assistant creation platform 110 to create a digital assistant respectively, and each digital assistant can interact with multiple users.

Some example embodiments of the present disclosure will be described in detail below with reference to the examples of the accompanying drawings. It should be understood that the pages illustrated in the accompanying drawings are merely examples and that various page designs may actually exist. Individual graphical elements on the page may have different arrangements and different visual representations, one or more of the elements may be omitted or replaced, and one or more other elements may be present. Embodiments of the present disclosure are not limited in this regard.

The digital assistant creation process described in embodiments of the present disclosure may be implemented in an assistant creation platform, a terminal device on which the assistant creation platform is installed, and/or a server corresponding to the assistant creation platform. In the following examples, for the sake of discussion, the assistant creation platform is described from the perspective of an assistant creation platform, such as the assistant creation platform 110 shown in FIG. 1. A page presented by the assistant creation platform 110 may be presented via a terminal device of the user 105, and user input may be received via the terminal device of the user 105. Throughout this specification, the user 105 who creates the digital assistant is sometimes referred to as an assistant creator, an assistant developer, and the like.

In some embodiments, the assistant creation platform 110 obtains registration information for the first assistant application platform. The registration information comprises at least a first interface definition for releasing a digital assistant on the first assistant application platform. The assistant application platform 130 (e.g., the assistant application platform 130-1, the assistant application platform 130-2, etc.) provides its respective registration information to the assistant creation platform 110 so that the assistant application platform 130 can autonomously access the assistant creation platform 110.

In some examples, the assistant application platform 130 may be any platform capable of providing the operation of a digital assistant. In some embodiments, the assistant application platform may correspond to a provider of various types of electronic devices, a provider of various types of application client platforms, and so forth. For example, the assistant creation platform may be a provider of Internet of Things (IoT) devices that, by registering to the assistant creation platform, may allow the assistant creator to release the digital assistant to run on the corresponding IoT device and for users of the IoT device to download, install, and use.

In some embodiments, the interface definition may define a standard application programming interface (API) and may include customized API Schema objects for defining input and output formats for the interface. For example, a first interface definition for releasing a digital assistant may define input and output parameters for the API interface in releasing the digital assistant.

An OpenAPI Schema object defines the input and output formats of the interface. In other words, assistant application platforms can describe the specifications of their own APIs in a computer language (e.g., JSON files, YAML files, etc.). Thus, even if the API specifications of different assistant application platforms are different, the assistant creation platform can go ahead and invoke the assistant application platform after the different assistant application platforms have described the specifications of the APIs in this manner.

The present disclosure for digital assistant creation is implemented in an assistant creation platform 110. The assistant creation platform 110 receives registration information that comprises an interface definition from the assistant application platform 130. In some embodiments, the interface definition in the registration message is an application programming interface specification that can be parsed by the assistant creation platform 110.

Such an application programming interface (API) definition specification may be a generic interface definition specification. For example, the OpenAPI (OAS) specification defines a standard, programming language-agnostic RESTful API specification that enables both humans and computers to understand the role of a service or function without touching any program source code or documentation, and without monitoring network communications. The OpenAPI specification allows both humans and computers to understand what a service or function does without touching any program source code or documentation, and without monitoring network communications. In some embodiments, the interface definition information may comprise OpenAPI Schema objects. Naturally, other interface definition specifications resolvable by the assistant creation platform may be selected in other embodiments to facilitate the ability of the assistant creation platform to resolve the interface information of the assistant application platform to accomplish the release of the created digital assistant to the assistant release platform.

In some embodiments, the registration information of the first assistant application platform obtained by the assistant creation platform 110 further comprises description information for the first assistant application platform. In some examples, the assistant application platform 130 provides its description information to the assistant creation platform 110. the description information may, for example, comprise identifying information (e.g., a name, an avatar, etc.), and a brief description of the assistant application platform. For example, the name of the assistant application platform 130, an avatar of the assistant application platform 130, a brief description of the assistant application platform 130, and the like description information is provided to the assistant creation platform 110. In some embodiments, some or all of the description information for the first assistant application platform may be subsequently presented to the assistant creator to have the assistant creator select the assistant application platform for release of his or her created digital assistant.

In some embodiments, the assistant creation platform 110 may obtain the registration information of the first assistant application platform in the following manner. First, the assistant creation platform 110 receives a registration request for the first assistant application platform. Then, the assistant creation platform 110 provides a registration page to the first assistant application platform. The registration page comprises an input control for registration information. Finally, the assistant creation platform 110 receives, via the registration page, the registration information of the first assistant application platform.

In some examples, the user 145 may send a registration request to the assistant creation platform 110. After receiving the registration request from the assistant application platform 130, the assistant creation platform 110 provides the user 145 with a registration page for inputting registration information. The assistant creation platform 110 then receives the registration information from the assistant application platform 130 based on the registration page.

In some embodiments, the assistant creation platform 110 receives release confirmation information for a target digital assistant, the release confirmation information indicating release of the target digital assistant to the first assistant application platform. Then, the assistant creation platform 110, in response to the release confirmation information, releases the target digital assistant to the first assistant application platform based on at least the first interface definition.

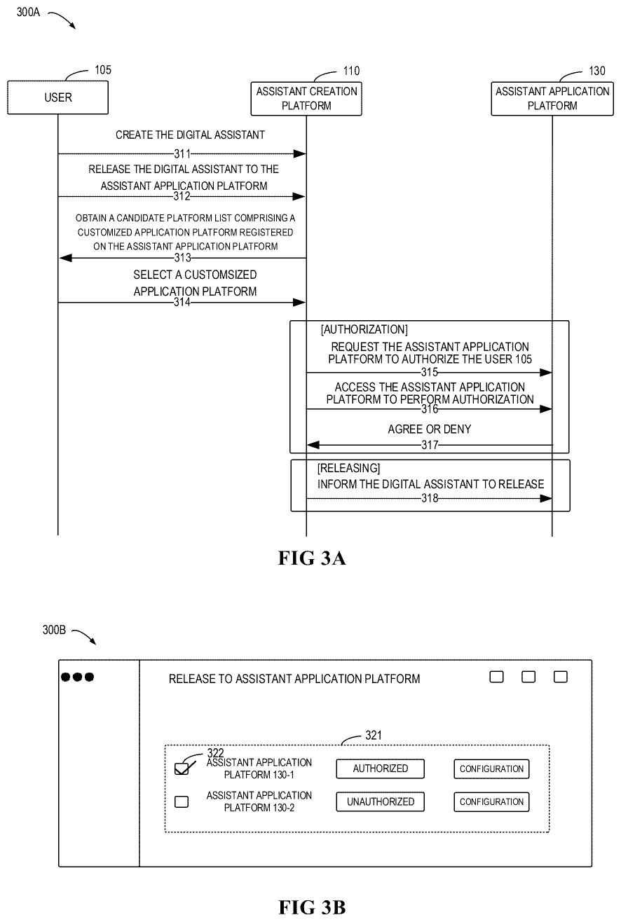

In some examples, the assistant creation platform 110 completes registering the assistant application platform 130 after receiving a registration message from the assistant application platform 130. Then, the assistant creator 105 creates the digital assistant 120 based on the assistant creation platform 110, selects the completed registered assistant application platform 130 as the release channel, and clicks on the confirmation for release. The assistant creation platform 110, in response to the release confirmation message, releases the digital assistant 120 to the completed registered assistant application platform 130 based on at least the first interface definition. The release of the digital assistant to the assistant application platform is described in detail below with reference to FIGS. 3A to 3B.

In some embodiments, after the assistant creation platform 110 releases the digital assistant 120 to the assistant application platform 130, it may also send a release notification to the assistant application platform 130 that the digital assistant 120 has been released. After the assistant creator 105 completes the release, the assistant creation platform 110 notifies the assistant application platform 130 that the digital assistant 120 has been released via a predefined interface for releasing the digital assistant 120.

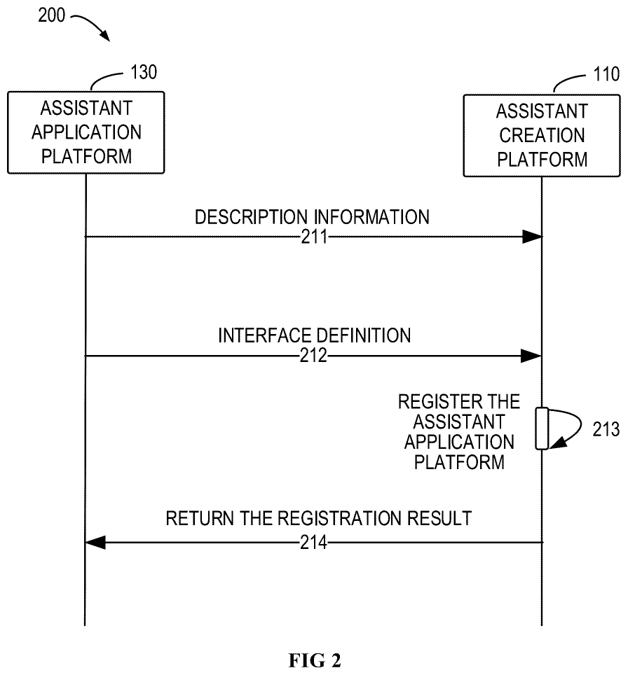

An example of using the registered assistant application platform of the present disclosure is described for ease of understanding with reference to FIG. 2. FIG. 2 illustrates a schematic diagram of a process 200 for registering an assistant application platform according to some embodiments of the present disclosure.

In process 200, the user 145 may send (211) description information to the assistant creation platform 110 and send (212) an interface definition to the assistant creation platform 110 to request registration of a release channel. In some examples, the user 145 may send the description information along with the interface definition to the assistant creation platform 110 to request registration of the assistant application platform 130 on the assistant creation platform 110.

After receiving the description information and the interface definitions from the assistant application platform 130, the assistant creation platform 110 registers (213) the assistant application platform 130 to serve as a channel for releasing digital assistants. In some examples, after receiving the description information and the interface definition from the assistant application platform 130, the assistant creation platform 110 reviews and registers the assistant application platform 130 to serve as a channel for releasing the digital assistant. Subsequently, the assistant creation platform 110 returns (214) the registration result to the assistant application platform 130.

The registered assistant application platform is described above with reference to FIG. 2. Through the process 200, the assistant application platform will be registered as one of the release platforms of the digital assistant. In some of the embodiments of the present disclosure, this is achieved by allowing the assistant application platform to be registered and adapted to the assistant creation platform as a candidate for release of digital assistants by means of providing a unified standard interface definition. This provides a more flexible way of expanding assistant application platforms, enabling more assistant application platforms to be able to act as a release channel for digital assistants through this solution. In addition, this also reduces the processing complexity of the assistant creation platform, eliminating the need to develop personalized interfaces and processing pathways for different assistant application platforms to enable the same digital assistant to be released and run on more assistant application platforms.

After one or more assistant application platforms 130 are registered to the assistant creation platform 110 via a customized route, the assistant creator (e.g., user 105) may create the digital assistant 120 on the assistant creation platform 110, select the assistant application platform 130 for which the registration has been completed as a release channel, and release the digital assistant 120. The assistant creator 105 will be described below with reference to FIG. 3A as creating the digital assistant 120 based on the assistant creation platform 110 and selecting the completed registered assistant application platform 130 as the release channel. FIG. 3A illustrates a schematic diagram of an example architecture for releasing a digital assistant to an assistant application platform according to some embodiments of the present disclosure.

In some embodiments, the assistant creation platform 110 provides a candidate platform list in response to detecting a release request for the target digital assistant, the candidate platform list comprising at least the registered first assistant application platform. Then, the assistant creation platform 110 receives the release confirmation information based on at least a selection of the first assistant application platform and a release confirmation of the target digital assistant.

In example architecture 300A, the user 105, sometimes referred to as the assistant creator 105, sends (311) a request to the assistant creation platform 110 to create the digital assistant 120. The assistant creation platform 110 creates the digital assistant 120 based on the request from the assistant creator 105. Subsequently, the assistant creator 105 sends (312) a request to the assistant creation platform 110 to release the digital assistant 120 to the assistant application platform 130.

The assistant creation platform 110 receives the request to release the digital assistant 120 and provides a list of candidate platforms to the assistant creator 105. The list of candidate platforms comprises at least registered assistant application platforms 130, including, for example, registered assistant application platform 130-1, assistant application platform 130-2, assistant application platform 130-3, and the like. FIG. 3B illustrates a schematic diagram of an example interface of a candidate platform list according to some embodiments of the present disclosure.

As shown in the example interface 300B of FIG. 3B, the assistant creation platform 110 provides the assistant creator 105 with a list of candidate platforms 321 that comprises at least the registered assistant application platforms 130-1. The assistant creator 105 may click on the selection block 322 to select the authorized assistant application platforms 130-1. In some examples, the list of candidate platforms includes one or more assistant application platforms provided by the platform itself registered one or more assistant application platforms and may also comprise one or more assistant application platforms that are provided by default by the digital creation platform.

The assistant creator 105 selects (314) the assistant application platform 130 based on the list of candidate platforms provided by the assistant creation platform 110. The assistant creation platform 110 then receives a release confirmation message based on the selection of the assistant creator 105 of at least one of the assistant application platforms 130 and confirmation of the release of the digital assistant 120.

The assistant creator 105 is described above with reference to FIG. 3A as creating the digital assistant 120 based on the assistant creation platform 110 and selecting the assistant application platform 130, which has completed registration, as the release channel. The following section will continue to describe, with reference to FIG. 3A, the process by which the assistant creation platform 110 receives authorization from the assistant application platform 130 for the assistant creator after the assistant creator 105 selects the completed registered assistant application platform 130 as the release channel.

In some embodiments, the registration information received by the assistant creation platform 110 further comprises an authorization mode of the first assistant application platform for an assistant creator. In some embodiments, the authorization mode indicates that the assistant application platform 130 needs to provide the assistant creation platform 110 with a way to authenticate API requests. For example, if the assistant application platform 130 requests authorization from the assistant creator, it will first perform an OAuth authorization operation.

In some embodiments, the assistant creation platform 110, in response to the release confirmation information, requests, based on the authorization mode, that the corresponding assistant application platform 130 perform authorization on a creator of the target digital assistant. The assistant creation platform 110 then releases, based on the first interface definition, the target digital assistant to the first assistant application platform in response to determining that the authorization of the assistant application platform 130 on the creator of the target digital assistant is completed.

Continuing with example framework 300A, after the assistant creation platform 110 receives the release confirmation message, if the assistant creation platform 110 requests the user 105 to perform an authorization operation, the assistant creation platform 110 requests (315) the assistant application platform 130 to authorize the assistant creator 105. In some embodiments, the assistant application platform 130 is accessed (316) to perform authorization on the user 105.

The assistant application platform 130 returns (317) an authorization result (e.g., agree to authorization or deny authorization) to the assistant creation platform 110. If authorization of the assistant creator 105 of the digital assistant 120 is complete, the assistant creation platform 110 releases the digital assistant 120 to the assistant application platform 130 according to the interface definition. The assistant creation platform 110 may also send (318) a release notification to inform the assistant application platform 130 that the digital assistant 120 has been released.

In some embodiments, the assistant creation platform may customize the scope of disclosure during registration, such as to be used by a part of the digital assistant creators or all of the digital assistant creators. Creators within the scope of disclosure may release their created digital assistants to the assistant application platform. The assistant application platform may define its own authorization model to facilitate authorization of the assistant creators.

The process used by the present disclosure for a digital assistant being released to the assistant application platform 130 is described above with reference to FIG. 3A. The following section describes providing an access link to a released digital assistant 120 on the assistant application platform 130 after the digital assistant 120 has been released, based on the second interface definition. In this way, after the digital assistant 120 is released, an access link to the digital assistant 120 on the corresponding assistant application platform 130 can be automatically created for the user 105, thus enabling the user 105 to quickly access the released digital assistant.

In some embodiments, the registration information also includes a second interface definition for accessing the digital assistant released on the first assistant application platform. The second interface definition (e.g., OpenIn share link) indicates that the assistant application platform 130 needs to provide a way to access a direct access link (OpenIn) to the digital assistant based on the OpenAPI schema, e.g., link, application link (APP Link).

In some embodiments, the interface definition may define a standard Application Programming Interface (API) and may include customized API Schema objects for defining input and output formats for the interface. For example, a second interface definition for accessing a digital assistant that has been released may define input and output parameters for the API interface in accessing the digital assistant.

In some embodiments, the assistant creation platform 110, in response to the target digital assistant being released to the first assistant application platform, provides, based on the second interface definition, an access link to the target digital assistant released on the first assistant application platform. Thereafter, the target digital assistant is accessed on the first assistant application platform via the access link.

In some examples, the assistant application platform 130, when providing registration information, may provide a second interface definition for the assistant creation platform 110 to provide an access link to the digital assistant 120 when the digital assistant 120 is released to the assistant application platform 130. Thus, the assistant creator 105 directly accesses the released digital assistant 120 through the access link. e.g., “XX application” provides the second interface definition when providing the registration information. If the assistant creator 105 creates “XX digital assistant” and releases it in “XX application”. In this case, the second interface definition is a link that can access the “XX digital assistant” directly.

In some embodiments, if the assistant application platform 130 does not provide the second interface definition when providing the registration information, the assistant creation platform 110 may provide textual explanations directly to the assistant creator 105 informing the assistant creator 105 how the assistant creator 105 should access the released digital assistant 120 on the assistant application platform 130.

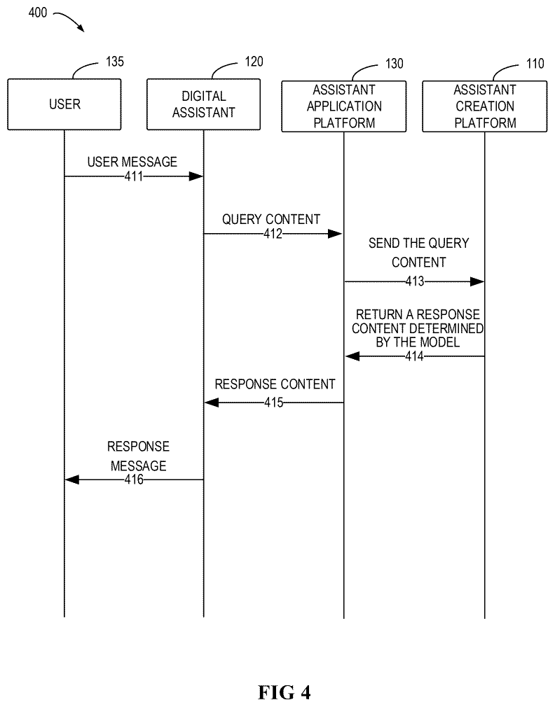

The above specification describes providing an access link to a released digital assistant 120 on the assistant application platform 130 after the digital assistant 120 has been released, based on the second interface definition. The description of the assistant creation platform 110 also associating the assistant application platform 130 to a third interface definition when receiving registration information to allow the assistant application platform 130 to interact with the digital assistant based on its own traffic scenarios is continued below with reference to FIG. 4. FIG. 4 illustrates a schematic diagram of an example architecture for a user to interact with a digital assistant according to some embodiments of the present disclosure.

In some embodiments, the assistant creation platform 110, in response to the registration information of the first assistant application platform, associates the first assistant application platform with a third interface definition that defines an interaction interface between a user and a digital assistant released on the first assistant application platform. The third interface definition is a model-based interaction interface (also referred to as a “Chat interface”) provided by the assistant creation platform 110.

It would be understood that the user 135 (sometimes referred to as the assistant interacting user on the assistant application platform side) interacts with the digital assistant 120 on the assistant application platform 130 side, where the assistant application platform 130 interacts via the third interface definition provided by the assistant creation platform 110 and will return results and display them. In some examples, the third interface definition is a fixed interface provided by the assistant creation platform 110.

In some embodiments, after the target digital assistant is released to the first assistant application platform, the assistant creation platform 110 receives, based on the third interface definition, query content of a user for the target digital assistant from the first assistant application platform. After receiving the query content, response content to the query content is determined by using the target digital assistant.

In some examples, the target digital assistant may determine response content for the query content based on a machine learning model (e.g., a language model LLM). In some embodiments, the assistant creation platform 110 provides the response content to the first assistant application platform based on the third interface definition, to generate a response message to the user by the first assistant application platform.

In some examples, after the digital assistant 120 is released to the assistant application platform 130, the assistant creation platform 110 receives query content for the digital assistant 120 from the assistant application platform 130 based on the third interface definition. After receiving the query content, the assistant creation platform 110 may determine the content of a response to the query content using the digital assistant 120. In some examples, the digital assistant 120 may determine the content of the response to the query content based on a machine learning model (e.g., the language model LLM). The assistant creation platform 110 then provides the response content to the assistant application platform 130 based on the third interface definition to generate a response message to the user by the assistant application platform 130.

In some embodiments, after obtaining registration information of the second assistant application platform, the assistant creation platform 110 associates the second assistant application platform with the third interface definition. After the target digital assistant is released to the second assistant application platform, the assistant creation platform 110 receives, based on the third interface definition, second query content of a user for the target digital assistant from the second assistant application platform. After receiving the query content, the assistant creation platform 110 determines, based on the query content, second response content for the second query content using the target digital assistant.

In some examples, the target digital assistant may determine response content for the query content based on a machine learning model (e.g., the language model LLM). In some embodiments, the assistant creation platform 110 provides the response content to the second assistant application platform to generate a response message to the user by the second assistant application platform based on the third interface definition.

In some examples, the assistant creation platform 110 associates the assistant application platform 130-1 to the third interface definition after obtaining registration information for the assistant application platform 130-1. After the digital assistant 120 is released to the assistant application platform 130-1, the assistant creation platform 110 receives a second query content for the digital assistant 120 from the assistant application platform 130-1 according to the third interface definition. After receiving the content of the second query, the assistant creation platform 110 may utilize the digital assistant 120 to determine the content of a response to the second query. The digital assistant 120 may determine the content of the response to the query content based on a machine learning model (e.g., a language model LLM). The assistant creation platform 110 then provides the response content to the assistant application platform 130-1 based on the third interface definition to generate a response message to the user by the assistant application platform

In the example architecture 400, the user 135 sends (411) a user message to the digital assistant 120. The user message indicates the message sent by the user 135 in the interaction window. The digital assistant 120 sends (412) query content to the assistant application platform 130. The query content is used to indicate the substance of the message sent by the user 135 in the interaction window. Upon receiving the query content, the assistant application platform 130 sends (413) the query content to the assistant creation platform 110 with an interaction request.

The assistant creation platform 110 returns (414) to the assistant application platform 130 a response content determined via the digital assistant 120 in response to the query content. The response content indicates the substantive content to be included in a message returned to the user 135 in the interaction window. The assistant application platform 130 receives the response content and returns (415) the response content to the digital assistant 120. The digital assistant 120 receives the response content and presents (416) the response content to the user 135 in the form of a response message.

For example, different assistant application platforms use the same third interface definition. The third interface definition may differentiate between the various assistant application platforms based on parameters corresponding to the different assistant application platforms. In some embodiments, the third interface definition also has respective interfaces for different modalities, such as, a speech modality for interaction in speech or a text modality for interaction in text.

In some examples, the message formats supported by different assistant application platforms may be varied, including, e.g., a card format, a text format, a speech format, and the like. As a result, for the messages provided to users at the sides of different assistant application platforms, the assistant creation platform needs to organize and present the messages for the users in the message presentation format supported by the assistant application platforms via the corresponding interfaces, thereby increasing development costs. The following description is based on a third interface definition for the user interacting with the digital assistant.

The assistant application platform 130 requests the assistant creation platform 110 to provide a third interface definition. After receiving the request, the assistant creation platform 110 makes the parameters comprised in the assistant application platform 130 structured. Then, the assistant application platform 130 determines to present the message content in a target presentation format.

For example, if the specifications of the API are described by the assistant application platform 130 in JSON text language, the assistant creation platform 110 informs the assistant application platform 130 what the text is, what the speech is, what the picture is, and so on, in the message content interacted between the user and the digital assistant. It is then up to the assistant application platform 130 to determine the presentation format for presenting the message content. For example, the assistant application platform 130 may choose to present the message content in the card form. If the assistant application platform 130 does not support card messages, the text and pictures may be presented separately as two messages; or the text may be converted to speech for play to the users; or the results determined by the machine learning model may be played in the form of a phone call by means of speech.

After the registration of the assistant application platform is completed, the assistant creation platform can initiate requests to the assistant application platform according to the API Schema at the time of registration to complete relevant operations. For example, releasing digital assistants, requesting authorization, sharing digital assistants, and so on. Accordingly, the assistant creation platform also provides a standard model-based interaction interface so that the assistant application platform can interact between users and digital assistants according to its traffic scenarios.

In summary, assistant creation platforms can provide the ability to customize channels and provide access support to the community. For example, assistant application platforms (IoT platforms, e.g., smart home, smart wearable device vendors), may access the assistant creation platform on their own, and assistant creators may also release digital assistants developed based on the model to the assistant application platform. Further, for internal corporation applications, for example internal scenarios of units such as governments and schools, the assistant creation platform can be accessed autonomously, which can bring the convenience of model application to the society, enterprises and institutions, and school students. Accordingly, for the assistant creation platform, the cost of the access channel can be saved.

FIG. 5 illustrates a flowchart of an example process 500 for digital assistant creation according to some embodiments of the present disclosure. The process 500 may be implemented at the assistant creation platform 110. The process 500 is described below with reference to FIG. 1.

At block 510, the assistant creation platform 110 obtains registration information of a first assistant application platform, the registration information comprising at least a first interface definition for releasing a digital assistant on the first assistant application platform.

At block 520, the assistant creation platform 110 receives release confirmation information for a target digital assistant, the release confirmation information indicating release of the target digital assistant to the first assistant application platform.

At block 530, the assistant creation platform 110 releases, in response to the release confirmation information, the target digital assistant to the first assistant application platform based on at least the first interface definition.

In some embodiments, the registration information further comprises an authorization mode of the first assistant application platform for an assistant creator, and wherein releasing the target digital assistant to the first assistant application platform comprises: in response to the release confirmation information, requesting, based on the authorization mode, the first assistant application platform to perform authorization on a creator of the target digital assistant; and releasing, based on the first interface definition, the target digital assistant to the first assistant application platform in response to determining that the authorization of the first assistant application platform on the creator of the target digital assistant is completed.

In some embodiments, the registration information further comprises a second interface definition for accessing a digital assistant released on the first assistant application platform, the process 500 further comprising: in response to the target digital assistant being released to the first assistant application platform, providing, based on the second interface definition, an access link to the target digital assistant released on the first assistant application platform, wherein the target digital assistant is accessed on the first assistant application platform via the access link.

In some embodiments, the process 500 further comprises: in response to the registration information of the first assistant application platform, associating the first assistant application platform with a third interface definition that defines an interaction interface between a user and a digital assistant released on the first assistant application platform.

In some embodiments, the process 500 further comprises: after the target digital assistant is released to the first assistant application platform, receiving, based on the third interface definition, query content of a user for the target digital assistant from the first assistant application platform; determining response content to the query content using the target digital assistant; and providing the response content to the first assistant application platform based on the third interface definition, to generate a response message to the user by the first assistant application platform.

In some embodiments, the process 500 further comprises: in response to obtaining registration information of a second assistant application platform, associating the second assistant application platform with the third interface definition; and after the target digital assistant is released to the second assistant application platform, receiving, based on the third interface definition, second query content of a user for the target digital assistant from the second assistant application platform; and determining, based on the query content, second response content for the second query content using the target digital assistant; and providing the second response content to the second assistant application platform based on the third interface definition, to generate a response message to the user by the second assistant application platform.

In some embodiments, receiving release confirmation information for a target digital assistant comprises: providing a candidate platform list in response to detecting a release request for the target digital assistant, the candidate platform list comprising at least the registered first assistant application platform; and receiving the release confirmation information based on at least a selection of the first assistant application platform and a release confirmation of the target digital assistant.

In some embodiments, the registration information further comprises description information for the first assistant application platform.

In some embodiments, obtaining registration information of the first assistant application platform comprises: receiving a registration request for the first assistant application platform; providing a registration page to the first assistant application platform, the registration page comprising an input control for registration information; and receiving, via the registration page, the registration information of the first assistant application platform.

In some embodiments, the method is implemented at an assistant creation platform and the interface definition in the registration information is based on an application programming interface specification that can be parsed by the assistant creation platform.

In some embodiments, the process 500 further comprises: sending, to the first assistant application platform, a release notification of the target digital assistant being released.

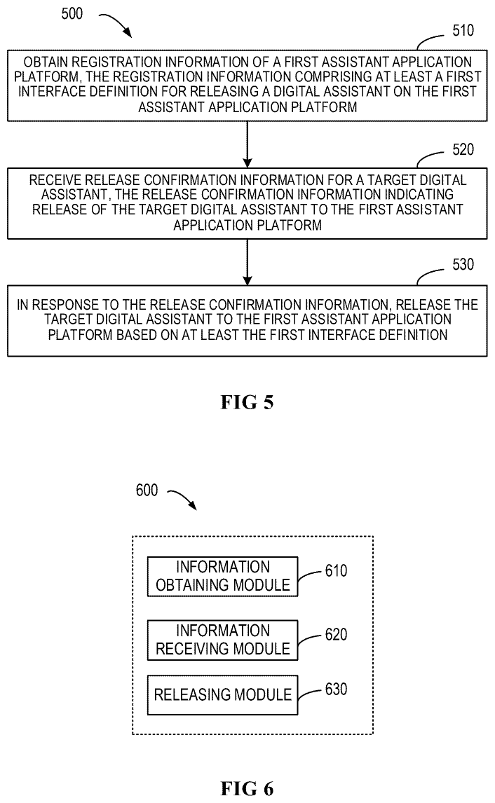

FIG. 6 illustrates a schematic structural block diagram of an example apparatus 600 for digital assistant creation according to some embodiments of the present disclosure. The apparatus 600 may be implemented or included in the assistant creation platform 110, for example. The various modules/components in the apparatus 600 may be implemented by hardware, software, firmware, or any combination thereof.

As shown, the apparatus 600 comprises an information obtaining module 610 configured to obtain registration information of a first assistant application platform, the registration information comprising at least a first interface definition for releasing a digital assistant on the first assistant application platform. The apparatus 600 further comprises an information receiving module 620 configured to receive release confirmation information for a target digital assistant, the release confirmation information indicating release of the target digital assistant to the first assistant application platform. The apparatus 600 further comprises a releasing module 630 configured to release, in response to the release confirmation information, the target digital assistant to the first assistant application platform based on at least the first interface definition.

In some embodiments, the registration information further comprises an authorization mode of the first assistant application platform for an assistant creator, and the releasing module 630 is further configured to: in response to the release confirmation information, request, based on the authorization mode, the first assistant application platform to perform authorization on a creator of the target digital assistant; and release, based on the first interface definition, the target digital assistant to the first assistant application platform in response to determining that the authorization of the first assistant application platform on the creator of the target digital assistant is completed.

In some embodiments, the registration information further comprises a second interface definition for accessing a digital assistant released on the first assistant application platform, and the apparatus 600 further comprises a link providing module configured to, in response to the target digital assistant being released to the first assistant application platform, provide, based on the second interface definition, an access link to the target digital assistant released on the first assistant application platform, wherein the target digital assistant is accessed on the first assistant application platform via the access link.

In some embodiments, the apparatus 600 further comprises an interface definition association module configured to, in response to the registration information of the first assistant application platform, associate the first assistant application platform with a third interface definition that defines an interaction interface between a user and a digital assistant released on the first assistant application platform.

In some embodiments, the apparatus 600 further comprises a content query module configured to, after the target digital assistant is released to the first assistant application platform, receive, based on the third interface definition, query content of a user for the target digital assistant from the first assistant application platform; determine response content to the query content using the target digital assistant; and provide the response content to the first assistant application platform based on the third interface definition, to generate a response message to the user by the first assistant application platform.

In some embodiments, the apparatus 600 further comprises a content providing module configured to, in response to obtaining registration information of a second assistant application platform, associate the second assistant application platform with the third interface definition; and after the target digital assistant is released to the second assistant application platform, receive, based on the third interface definition, second query content of a user for the target digital assistant from the second assistant application platform; and determine, based on the query content, second response content for the second query content using the target digital assistant; and provide the second response content to the second assistant application platform based on the third interface definition, to generate a response message to the user by the second assistant application platform.

In some embodiments, the information receiving module 620 is further configured to provide a candidate platform list in response to detecting a release request for the target digital assistant, the candidate platform list comprising at least the registered first assistant application platform; and receive the release confirmation information based on at least a selection of the first assistant application platform and a release confirmation of the target digital assistant.

In some embodiments, the registration information further comprises description information for the first assistant application platform.

In some embodiments, the information obtaining module 610 is further configured to receive a registration request for the first assistant application platform; provide a registration page to the first assistant application platform, the registration page comprising an input control for registration information; and receive, via the registration page, the registration information of the first assistant application platform.

In some embodiments, the method is implemented at an assistant creation platform and the interface definition in the registration information is based on an application programming interface specification parseable by the assistant creation platform.

In some embodiments, the apparatus 600 further comprises a notification releasing module configured to send, to the first assistant application platform, a release notification of the target digital assistant being released.

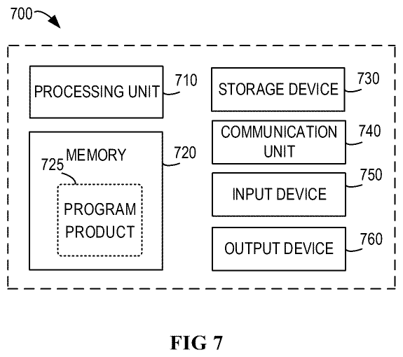

FIG. 7 illustrates a block diagram of an electronic device 700 in which one or more embodiments of the present disclosure may be implemented. It would be appreciated that the electronic device 700 shown in FIG. 7 is only an example and should not constitute any restriction on the function and scope of the embodiments described in this specification. The electronic device 700 shown in FIG. 7 may include or be implemented as the assistant creation platform 110 of FIG. 1, or the apparatus 600 of FIG. 6.

As shown in FIG. 7, the electronic device 700 is in the form of a general electronic device. The components of the electronic device 700 may include, but are not limited to, one or more processors or processing units 710, a memory 720, a storage device 730, one or more communication units 740, one or more input devices 750, and one or more output devices 760. The processing units 710 may be actual or virtual processors and can execute various processes according to the programs stored in the memory 720. In a multiprocessor system, multiple processing units execute computer executable instructions in parallel to improve the parallel processing capability of the electronic device 700.

The electronic device 700 typically includes a variety of computer storage media. Such media can be any available media that is accessible to the electronic device 700, including but not limited to volatile and non-volatile media, removable and non-removable media. The memory 720 can be volatile memory (such as registers, caches, random access memory (RAM)), nonvolatile memory (such as a read-only memory (ROM), an electrically erasable programmable read-only memory (EEPROM), a flash memory), or some combination thereof. The storage device 730 can be any removable or non-removable medium, and can include machine-readable medium, such as a flash drive, a disk, or any other medium which can store information and/or data and can be accessed within the electronic device 700.

The electronic device 700 may further include additional removable/non-removable, volatile/non-volatile storage medium. Although not shown in FIG. 7, a disk driver for reading from or writing to a removable, non-volatile disk (such as a “floppy disk”), and an optical disk driver for reading from or writing to a removable, non-volatile optical disk can be provided. In these cases, each driver may be connected to the bus (not shown) by one or more data medium interfaces. The memory 720 can include a computer program product 725, which comprises one or more program modules configured to execute various methods or actions of the various embodiments disclosed in this specification.

The communication unit 740 implements communication with other electronic devices via a communication medium. In addition, functions of components in the electronic device 700 may be implemented by a single computing cluster or multiple computing machines, which can communicate through a communication connection. Therefore, the electronic device 700 may be operated in a networking environment using a logical connection with one or more other servers, a network personal computer (PC), or another network node.

The input device 750 may be one or more input devices, such as a mouse, a keyboard, a trackball, etc. The output device 760 may be one or more output devices, such as a display, a speaker, a printer, etc. The electronic device 700 may also communicate with one or more external devices (not shown) through the communication unit 740 as required. The external device, such as a storage device, a display device, etc., communicate with one or more devices that enable users to interact with the electronic device 700, or communicate with any device (for example, a network card, a modem, etc.) that makes the electronic device 700 communicate with one or more other computing devices. Such communication may be executed via an input/output (I/O) interface (not shown).

According to example implementation of the present disclosure, there is provided a computer-readable storage medium on which a computer-executable instruction or computer program is stored, wherein the computer-executable instructions are executed by a processor to implement the methods described above.

Various aspects of the present disclosure are described in this specification with reference to the flow chart and/or the block diagram of the method, the device, the apparatus and the computer program product implemented in accordance with the present disclosure. It would be appreciated that each block of the flowchart and/or the block diagram and the combination of each block in the flowchart and/or the block diagram may be implemented by computer-readable program instructions.

These computer-readable program instructions may be provided to the processing units of general-purpose computers, special computers or other programmable data processing devices to produce a machine that generates a device to implement the functions/acts specified in one or more blocks in the flow chart and/or the block diagram when these instructions are executed through the processing units of the computer or other programmable data processing devices. These computer-readable program instructions may also be stored in a computer-readable storage medium. These instructions enable a computer, a programmable data processing device and/or other devices to work in a specific way. Therefore, the computer-readable medium containing the instructions includes a product, which includes instructions to implement various aspects of the functions/acts specified in one or more blocks in the flowchart and/or the block diagram.

The computer-readable program instructions may be loaded onto a computer, other programmable data processing apparatus, or other devices, so that a series of operational steps can be performed on a computer, other programmable data processing apparatus, or other devices, to generate a computer-implemented process, such that the instructions which execute on a computer, other programmable data processing apparatus, or other devices implement the functions/acts specified in one or more blocks in the flowchart and/or the block diagram.

The flowchart and the block diagram in the drawings show the possible architecture, functions and operations of the system, the method and the computer program product implemented in accordance with the present disclosure. In this regard, each block in the flowchart or the block diagram may represent a part of a module, a program segment or instructions, which contains one or more executable instructions for implementing the specified logic function. In some alternative implementations, the functions marked in the block may also occur in a different order from those marked in the drawings. For example, two consecutive blocks may actually be executed in parallel, and sometimes can also be executed in a reverse order, depending on the function involved. It should also be noted that each block in the block diagram and/or the flowchart, and combinations of blocks in the block diagram and/or the flowchart, may be implemented by a dedicated hardware-based system that performs the specified functions or acts, or by the combination of dedicated hardware and computer instructions.

Each implementation of the present disclosure has been described above. The above description provides examples, not exhaustive, and is not limited to the disclosed implementations. Without departing from the scope and spirit of the described implementations, many modifications and changes are obvious to those of ordinary skill in the art. The selection of terms used in this article aims to best explain the principles, practical application or improvement of technology in the market of each implementation, or to enable others of ordinary skill in the art to understand the various embodiments disclosed in this specification.

1. A method of digital assistant creation, comprising:
obtaining registration information of a first assistant application platform, the registration information comprising at least a first interface definition for releasing a digital assistant on the first assistant application platform;
receiving release confirmation information for a target digital assistant, the release confirmation information indicating release of the target digital assistant to the first assistant application platform; and
in response to the release confirmation information, releasing the target digital assistant to the first assistant application platform based on at least the first interface definition.

2. The method of claim 1, wherein the registration information further comprises an authorization mode of the first assistant application platform for an assistant creator, and wherein releasing the target digital assistant to the first assistant application platform comprises:
in response to the release confirmation information, requesting, based on the authorization mode, the first assistant application platform to perform authorization on a creator of the target digital assistant; and
releasing, based on the first interface definition, the target digital assistant to the first assistant application platform in response to determining that the authorization of the first assistant application platform on the creator of the target digital assistant is completed.

3. The method of claim 1, wherein the registration information further comprises a second interface definition for accessing a digital assistant released on the first assistant application platform, the method further comprising:
in response to the target digital assistant being released to the first assistant application platform, providing, based on the second interface definition, an access link to the target digital assistant released on the first assistant application platform, wherein the target digital assistant is accessed on the first assistant application platform via the access link.

4. The method of claim 1, further comprising:
in response to the registration information of the first assistant application platform, associating the first assistant application platform with a third interface definition that defines an interaction interface between a user and a digital assistant released on the first assistant application platform.

5. The method of claim 4, further comprising:
after the target digital assistant is released to the first assistant application platform, receiving, based on the third interface definition, query content of a user for the target digital assistant from the first assistant application platform;
determining response content to the query content using the target digital assistant; and
providing the response content to the first assistant application platform based on the third interface definition, to generate a response message to the user by the first assistant application platform.

6. The method of claim 4, further comprising:
in response to obtaining registration information of a second assistant application platform, associating the second assistant application platform with the third interface definition; and
after the target digital assistant is released to the second assistant application platform, receiving, based on the third interface definition, second query content of a user for the target digital assistant from the second assistant application platform; and
determining, based on the second query content, second response content for the second query content using the target digital assistant; and
providing the second response content to the second assistant application platform based on the third interface definition, to generate a second response message to the user by the second assistant application platform.

7. The method of claim 1, wherein receiving release confirmation information for a target digital assistant comprises:
providing a candidate platform list in response to detecting a release request for the target digital assistant, the candidate platform list comprising at least the registered first assistant application platform; and
receiving the release confirmation information based on at least a selection of the first assistant application platform and a release confirmation of the target digital assistant.

8. The method of claim 1, wherein the registration information further comprises description information for the first assistant application platform.

9. The method of claim 1, wherein obtaining registration information of the first assistant application platform comprises:
receiving a registration request for the first assistant application platform;
providing a registration page to the first assistant application platform, the registration page comprising an input control for receiving registration information; and
receiving, via the registration page, the registration information of the first assistant application platform.

10. The method of claim 1, wherein the registration information is received at an assistant creation platform distinct from the assistant application platform, and wherein the interface definition in the registration information is based on an application programming interface specification parseable by the assistant creation platform.

11. The method of claim 1, further comprising:
sending, to the first assistant application platform, a release notification of the target digital assistant being released.

12. An electronic device, comprising:
at least one processing unit; and
at least one memory coupled to the at least one processing unit and storing instructions for execution by the at least one processing unit, the instructions, when executed by the at least one processing unit, causing the electronic device to perform operations comprising:
obtaining registration information of a first assistant application platform, the registration information comprising at least a first interface definition for releasing a digital assistant on the first assistant application platform;
receiving release confirmation information for a target digital assistant, the release confirmation information indicating release of the target digital assistant to the first assistant application platform; and
in response to the release confirmation information, releasing the target digital assistant to the first assistant application platform based on at least the first interface definition.

13. The electronic device of claim 12, wherein the registration information further comprises an authorization mode of the first assistant application platform for an assistant creator, and wherein releasing the target digital assistant to the first assistant application platform comprises:
in response to the release confirmation information, requesting, based on the authorization mode, the first assistant application platform to perform authorization on a creator of the target digital assistant; and
releasing, based on the first interface definition, the target digital assistant to the first assistant application platform in response to determining that the authorization of the first assistant application platform on the creator of the target digital assistant is completed.

14. The electronic device of claim 12, wherein the registration information further comprises a second interface definition for accessing a digital assistant released on the first assistant application platform, the operations further comprising:
in response to the target digital assistant being released to the first assistant application platform, providing, based on the second interface definition, an access link to the target digital assistant released on the first assistant application platform, wherein the target digital assistant is accessed on the first assistant application platform via the access link.

15. The electronic device of claim 12, wherein the operations further comprise:
in response to the registration information of the first assistant application platform, associating the first assistant application platform with a third interface definition that defines an interaction interface between a user and a digital assistant released on the first assistant application platform.

16. The electronic device of claim 15, wherein the operations further comprise:
after the target digital assistant is released to the first assistant application platform, receiving, based on the third interface definition, query content of a user for the target digital assistant from the first assistant application platform;
determining response content to the query content using the target digital assistant; and
providing the response content to the first assistant application platform based on the third interface definition, to generate a response message to the user by the first assistant application platform.

17. The electronic device of claim 15, wherein the operations further comprise:
in response to obtaining registration information of a second assistant application platform, associating the second assistant application platform with the third interface definition; and
after the target digital assistant is released to the second assistant application platform, receiving, based on the third interface definition, second query content of a user for the target digital assistant from the second assistant application platform; and
determining, based on the second query content, second response content for the second query content using the target digital assistant; and
providing the second response content to the second assistant application platform based on the third interface definition, to generate a second response message to the user by the second assistant application platform.

18. The electronic device of claim 12, wherein receiving release confirmation information for a target digital assistant comprises:
providing a candidate platform list in response to detecting a release request for the target digital assistant, the candidate platform list comprising at least the registered first assistant application platform; and
receiving the release confirmation information based on at least a selection of the first assistant application platform and a release confirmation of the target digital assistant.

19. The electronic device of claim 12, wherein the registration information further comprises description information for the first assistant application platform.

20. A non-transitory computer-readable storage medium having a computer program stored thereon, the computer program being executable by a processor to perform operations comprising:
obtaining registration information of a first assistant application platform, the registration information comprising at least a first interface definition for releasing a digital assistant on the first assistant application platform;
receiving release confirmation information for a target digital assistant, the release confirmation information indicating release of the target digital assistant to the first assistant application platform; and
in response to the release confirmation information, releasing the target digital assistant to the first assistant application platform based on at least the first interface definition.
